(19) United States
(12) Patent Application Publication
(10) Pub. No.: US 2006/0267230 A1
(43) Pub. Date: Nov. 30, 2006

(54) Artificial marble having a crack pattern and method for preparing thereof

(76) Inventors: Do Choon Rha, Seoul (KR); Eung Seo Park, Yeosu-si (KR); Jae Wook Juen, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/499,224

(22) Filed: Aug. 4, 2006

Related U.S. Application Data
(63) Continuation-in-part of application No. PCT/KR05/04355, filed on Dec. 16, 2005.

(30) Foreign Application Priority Data
Dec. 17, 2004 (KR) 10-2004-0107876

(51) Int. Cl. B28B 7/04

(52) U.S. Cl. 264/39

(57) ABSTRACT

The method for preparing an artificial marble having a crack pattern is disclosed. The method includes preparing a first and a second polymeric compositions of different viscosities; pouring the first polymeric composition into a molding cell; pouring the second polymeric composition onto the first polymeric composition; allowing migration of the first polymeric composition to the upper part of the second polymeric composition due to the difference in viscosity between the first and the second compositions; and curing the two polymeric compositions to form a crack pattern. The viscosity of the first polymeric composition is lower than that of the second polymeric composition.

### CROSS-REFERENCE TO RELATED APPLICATIONS

This application is a continuation-in-part application under 35 U.S.C. §365 (c) claiming the benefit of the filing date of PCT Application No. PCT/KR2005/004355 designating the United States, filed Dec. 16, 2005. The PCT Application claims the benefit of the earlier filing date of Korean Patent Application No. 10-2004-0107876, filed Dec. 17, 2004. The contents of the Korean Patent Application No. 10-2004-0107876 and the International Application No. PCT/KR2005/004355 are incorporated herein by reference in their entirety.

### BACKGROUND OF THE INVENTION

1. Field of the Invention

The present invention relates to a method for preparing an artificial marble or a solid surface material. More particularly, the present invention relates to a method for preparing an artificial marble with a crack pattern, using at least two slurries of different viscosities.

2. Description of the Related Technology

In general, artificial marbles have been widely used as a material for kitchen top boards, wash bowls, dressing tables, bathtubs, counter tables, wall materials, house interior articles, etc. “Artificial marble,” as used herein, is also referred to as “solid surface material.” An acrylic artificial marble is typically produced by curing a resin mixture, which includes an acrylic resin syrup, an inorganic filler, an initiator, pigments, curing agents and dispersing agents. To improve the appearance of the artificial marble, solid particles, such as crushed artificial marble chips, may also be added to the resin mixture. The term “chip,” as used herein, means a particle prepared by pulverizing a cured artificial marble.

To meet various purposes, artificial marbles having various patterns and designs have been developed. However, conventional artificial marbles have certain limitations in providing various patterns and thus cannot satisfy various needs of consumers.

Korean Patent No. 414676 discloses a method for preparing a crack-patterned artificial marble by using crack paints such as nitrocellulose lacquer. This method, however, requires a gel coating step and a thermal treating step, which complicate the manufacturing process and increase the costs. In order to solve the problems, the present inventors have developed a crack-patterned artificial marble by using at least two slurries of different viscosities.

### SUMMARY OF CERTAIN INVENTIVE ASPECTS

One aspect of the invention provides a method for preparing an artificial marble having a crack pattern. The method comprises: providing a first polymeric composition; adding a second polymeric composition over the first polymeric composition; allowing at least a portion of the first polymeric composition to migrate to the upper part of the second polymeric composition; and curing the first and the second polymeric compositions. In the method, the viscosity of the first polymeric composition is lower than the viscosity of the second polymeric composition.

In the above method, the upper part of the second polymeric composition may comprise the top surface of the second polymeric composition. The first polymeric composition may have a fluidity ranging from about 11 cm/min to about 16 cm/min. The second polymeric composition may have a fluidity ranging from about 10 cm/min to about 14 cm/min. The difference in fluidity between the first and the second polymeric compositions may be more than about 1 cm/min. The difference in fluidity between the first and the second polymeric compositions may be between about 1 cm/min and about 5 cm/min.

The above method may further comprise polishing the surface of the cured composition. In the method, each of the first and the second polymeric compositions may comprise an acrylic resin syrup, an initiator, and an inorganic filler. The fluidity of the first and the second polymeric compositions may be adjusted by changing the amount of the inorganic filler in the compositions. The fluidity of the first and the second polymeric compositions may be adjusted by adding polymethacrylate to the compositions.

In the method, each of the first and the second polymeric compositions may further comprise marble chips. Each of the first and the second polymeric compositions may comprise about 100 parts by weight of an acrylic resin syrup, about 0.1 to about 10 parts by weight of an initiator, and about 20 to about 250 parts by weight of an inorganic filler. Each of the first and the second polymeric compositions may further comprise about 0 to about 100 parts by weight of marble chips. In the method, the second polymeric composition may be provided onto the first polymeric composition in a zigzag or a straight manner. Curing the first and the second polymeric compositions may comprise heating the compositions to a temperature between about 15° C. and about 80° C. Curing the first and the second polymeric compositions may comprise heating the compositions to a temperature between about 60° C. and about 80° C.

Another aspect of the invention provides an artificial marble having a crack pattern made by the method described above.

Yet another aspect of the invention provides an article comprising the artificial marble described above.

### BRIEF DESCRIPTION OF THE DRAWINGS

FIG. 1(A) is a photograph showing a surface pattern of an artificial marble obtained in Example 1.

FIG. 1(B) is a photograph showing a surface pattern of an artificial marble obtained in Example 2.

### DETAILED DESCRIPTION OF EMBODIMENTS

A method for preparing an artificial marble having a crack pattern on its surface is described. In one embodiment, the method includes: preparing a first and a second polymeric compositions of different viscosities; pouring the first polymeric composition into a molding cell; pouring the second polymeric composition onto the first polymeric composition; allowing at least a portion of the first polymeric composition to migrate to the upper part or top surface of the second polymeric composition; and curing the two polymeric compositions to form a crack pattern. In the method, the viscosity of the first polymeric composition is lower than that of the second polymeric composition. The difference in viscosity between the compositions causes the migration of the first polymeric composition. The method may further include polishing the surface of the cured composition.

Preparation of Polymeric Compositions

According to one embodiment, the first and the second polymeric compositions are prepared as follows. Each of the first and the second polymeric compositions may include an acrylic resin syrup, an inorganic filler, and an initiator. The polymeric compositions may also include marble chips and other additives. The first and the second polymeric compositions may include the same or similar components. However, the first and the second polymeric compositions are adjusted to have different viscosities. Each of the components in the compositions will now be described below in detail.

The acrylic resin syrup may include at least one acrylic polymer. In one embodiment, the acrylic resin syrup includes one or more acrylic monomers and optionally one or more acrylic polymer compounds. In another embodiment, the acrylic resin may include polyacrylate.

The inorganic filler may be an inorganic filler of any kind known in the art. Examples of the inorganic filler include, but are not limited to, calcium carbonate, aluminum hydroxide, and magnesium hydroxide. Among other things, aluminum hydroxide provides excellent transparency and elegant appearance to the artificial marble.

The polymeric compositions may also include an initiator. Examples of the initiator include, but are not limited to, peroxide compounds, such as benzoyl peroxide, lauroyl peroxide, butyl hydroperoxide, and cumene hydroperoxide, and azo compounds such as azobisisobutylonitrile.

In certain embodiments, the polymeric compositions may include marble chips. The marble chips can be formed of a solid material of any kind. Examples of a material for the marble chips include, but are not limited to, an artificial marble, a natural marble, and a rock. An artificial marble prepared according to embodiments described below can also be used as the marble chip after being pulverized.

Marble chips can have various colors, shapes, and sizes. In certain embodiments, the marble chips may have one or more colors which are different from the colors of pigments used for the compositions. In one embodiment, the marble chips have a diameter or particle size from about 0.1 mm to about 5 mm.

The marble chips are prepared by crushing or pulverizing an artificial or natural marble or a rock into particles of desired sizes. In other embodiments, the artificial marble can be pulverized to be used as a marble chip. One of ordinary skill in the art will appreciate other appropriate materials for the marble chips and other appropriate methods for producing the marble chips in desired sizes.

The polymeric compositions may also include various other additives known in the art for use in an artificial marble product. Examples of additives include, but are not limited to, light stabilizers, heat stabilizers, impact modifiers, flame retardants, lubricants, releasing agents, pigments, and dyes.

In one embodiment, each of the first and the second polymeric compositions includes about 100 parts by weight of the acrylic resin syrup, about 0.1 to about 10 parts by weight of the initiator and about 20 to about 250 parts by weight of the inorganic filler. Each of the first and the second polymeric compositions may also include about 0 to about 100 parts by weight of the marble chips. The composition of the polymeric compositions may be varied depending upon desired physical properties, colors, patterns, and appearance of the resulting artificial marble. In one embodiment, the first and the second polymeric compositions are in the form of slurry. In other embodiments, the polymeric compositions may be in any suitable form which can be used to form an artificial marble.

The viscosities of the first and the second polymeric compositions are different from each other. The viscosities of the compositions are controlled by adjusting the amount of polymethacrylate and/or the inorganic filler in the compositions. One of ordinary skill in the art will appreciate how to control the viscosities of the polymeric compositions.

In one embodiment, the first polymeric composition has a lower viscosity than the second polymeric composition. The viscosities of the first and the second polymeric compositions cannot be measured using a conventional viscometer because of the inorganic filler and the marbles chips in the compositions. Instead, the viscosities are measured in terms of fluidity. “Fluidity,” as used herein, refers to a value obtained by dropping about 30 g of a slurry onto a glass plate, allowing the slurry to flow for about 1 minute, and measuring the diameter of the slurry. The unit of fluidity is “length/time.” “Centimeter/minute (cm/min)” will be used hereinafter as the unit of fluidity unless otherwise indicated. Although the “fluidity” used in this description is not the reciprocal of the “viscosity” conventionally used in the art, a high fluidity indicates a low viscosity. In other words, the higher the fluidity of a slurry is, the lower the viscosity of the slurry is.

In one embodiment, the first polymeric composition has a fluidity ranging from about 11 to about 16 cm/min (for specific gravity: about 1.62-1.4). The term, “specific gravity,” as used herein, refers to a measure of the density of a material. It is also referred to as “relative density.” It is dimensionless, equal to the density of the material divided by the density of water. The second polymeric composition may have a fluidity ranging from about 10 to about 14 cm/min (for specific gravity: about 1.65-1.5). In one embodiment, the difference in fluidity between the two polymeric compositions is more than about 1 cm/min, optionally about 1 cm/min to about 5 cm/min. In one embodiment, in order to manifest a crack pattern, the fluidity of the first polymeric composition is higher than that of the second polymeric composition.

Forming Artificial Marble

In one embodiment, an artificial marble can be formed by the following process. First, the first polymeric composition is poured into a molding cell. In other embodiments, the first polymeric composition may be provided into any suitable mold which can provide a frame for an artificial marble. Then, the second polymeric composition is poured onto the first polymeric composition.

Subsequently, the first polymeric composition is allowed to migrate to the upper part of the second polymeric composition. The migration is caused by the difference in viscosity or fluidity between the first and the second compositions. Because the first polymeric composition has a low viscosity (i.e., a high fluidity), at least a portion of the composition migrates to the upper part or top surface of the second polymeric composition. On the other hand, at least a portion of the second polymeric composition having a high viscosity (i.e., a low fluidity) migrates to the lower part of the first polymeric composition. In one embodiment, the migration is allowed to occur for a period of time from when the first polymeric composition begins to appear on the surface of the second polymeric composition to when the two polymeric compositions become completely cured. In one embodiment, the migration occurs for a period of at most about 1 hour, optionally between about 1 second and about 40 minutes.

Crack patterns may be varied by changing the manner of pouring the second polymeric composition onto the first polymeric composition. In one embodiment, the second polymeric composition is poured onto the first polymeric composition in a zigzag manner, which results in a discontinuous crack pattern. In another embodiment, the second polymeric composition may be poured onto the first polymeric composition in a straight manner, which results in a continuous crack pattern.

The two polymeric compositions are cured according to an ordinary method after the migration has occurred to a desired extent so that the cured product has a crack pattern on its surface. In one embodiment, the curing can be conducted autogenically by merely exposing the compositions to a temperature between about 15° C. and about 80° C., optionally between about 60° C. and about 80° C.

The cured composition may be polished to have a smooth surface. The polishing may be conducted using any suitable method known in the art, such as sanding or grinding.

In one embodiment, an article including the artificial marble described above is provided. Examples of the article include, but are not limited to, kitchen top boards, wash bowls, dressing tables, bathtubs, counter tables, wall materials, and house interior articles. A skilled artisan will appreciate that the artificial marble of the embodiments may apply to various other kinds of articles.

The invention may be better understood by reference to the following examples which are intended for the purpose of illustration and are not to be construed in any way as limiting the scope of the present invention, which is defined in the claims appended hereto. In the following examples, all parts and percentage are by weight unless otherwise indicated.

### EXAMPLES

### Example 1

Polymeric compositions were prepared as follows. A first resin mixture was prepared by mixing 100 parts by weight of methyl methacrylate syrup consisting of 30% of polymethylmethacrylate and 70% of methylmethacrylate, 100 parts by weight of aluminum hydroxide, 1 parts by weight of benzoyl peroxide and 0.1 part by weight of white pigment. The fluidity of the first resin mixture was 13.5 cm/min.

A second resin mixture was conducted in the same manner as the above first polymeric composition except that 160 parts by weight of aluminum hydroxide was used instead of 100 parts by weight of aluminum hydroxide. The fluidity of the second resin mixture was 10.1 cm/min.

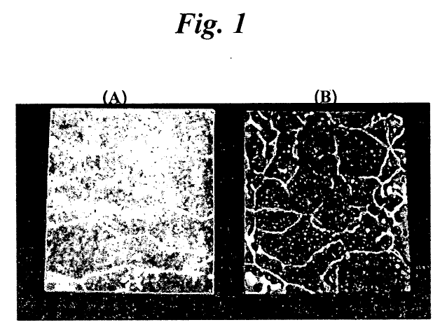

Using the polymeric compositions, an artificial marble was formed by the following process. The first polymeric composition was poured onto a conveyer belt. Then, the second polymeric composition was poured onto the first polymeric composition in a zigzag manner. The first polymeric composition was then allowed to migrate to the upper part of the second polymeric composition. While the conveyer belt was moving, the two polymeric compositions on the conveyer belt were cured to obtain a crack-patterned marble. The surface pattern of the resulting product is shown in FIG. 1(A).

### Example 2

In Example 2, a first polymeric composition was prepared in the same manner as the above first polymeric composition except that 80 parts by weight of aluminum hydroxide was used instead of 100 parts by weight of aluminum hydroxide. The fluidity of the first polymeric composition was 15.7 cm/min. As a second polymeric composition, the first resin mixture having a fluidity of 13.5 cm/min in Example 1 was used.

The first polymeric composition was poured onto a conveyer belt. Then, the second polymeric composition was poured onto the first polymeric composition in a straight manner. The first polymeric composition was then allowed to migrate to the upper part of the second polymeric composition. While the conveyer belt was moving, the two polymeric compositions on the conveyer belt were cured to obtain a crack-patterned marble. The surface pattern of the resulting product is shown in FIG. 1(B).

### Comparative Example 1

In Comparative Example 1, a first polymeric composition was prepared in the same manner as the above first polymeric composition except that 105 parts by weight of aluminum hydroxide was used instead of 100 parts by weight of aluminum hydroxide. The fluidity of the first polymeric composition was 13.2 cm/min. A second polymeric composition was prepared in the same manner as the above first polymeric composition except that 60 parts by weight of aluminum hydroxide was used instead of 100 parts by weight of aluminum hydroxide. The fluidity of the second polymeric composition was 16.4 cm/min. An artificial marble was formed in the same manner as in Example 1. The results from Examples 1 and 2 and Comparative Example 1 are shown in Table 1.

TABLE 1

| | Examples | | Comparative |
|---|---|---|---|
| | 1 | 2 | example |
| Fluidity of the first | 13.5 cm/mm | 15.7 cm/mm | 13.2 cm/mm |
| composition | | | |
| Fluidity of the second | 10.1 cm/mm | 13.5 cm/mm | 16.4 cm/mm |
| composition | | | |
| Crack pattern | discontinuous | continuous | none |

Although this invention has been described in terms of certain embodiments, other embodiments that are apparent to those of ordinary skill in the art, including embodiments that do not provide all of the features and advantages set forth herein, are also within the scope of this invention. Accordingly, the scope of the present invention is defined only by reference to the appended claims.

What is claimed is:

1. A method for preparing an artificial marble having a crack pattern, the method comprising:
providing a first polymeric composition;
adding a second polymeric composition over the first polymeric composition;
allowing at least a portion of the first polymeric composition to migrate to the upper part of the second polymeric composition; and
curing the first and the second polymeric compositions,
wherein the viscosity of the first polymeric composition is lower than the viscosity of the second polymeric composition.

2. The method of claim 1, wherein the upper part of the second polymeric composition comprises the top surface of the second polymeric composition.

3. The method of claim 1, wherein the first polymeric composition has a fluidity ranging from about 11 cm/min to about 16 cm/min.

4. The method of claim 1, wherein the second polymeric composition has a fluidity ranging from about 10 cm/min to about 14 cm/min.

5. The method of claim 1, wherein the difference in fluidity between the first and the second polymeric compositions is more than about 1 cm/min.

6. The method of claim 1, wherein the difference in fluidity between the first and the second polymeric compositions is between about 1 cm/min and about 5 cm/min.

7. The method of claim 1, further comprising polishing the surface of the cured composition.

8. The method of claim 1, wherein each of the first and the second polymeric compositions comprises an acrylic resin syrup, an initiator, and an inorganic filler.

9. The method of claim 8, wherein the fluidities of the first and the second polymeric compositions are adjusted by changing the amount of the inorganic filler in the compositions.

10. The method of claim 8, wherein the fluidities of the first and the second polymeric compositions are adjusted by adding polymethacrylate to the compositions.

11. The method of claim 8, wherein each of the first and the second polymeric compositions further comprises marble chips.

12. The method of claim 1, wherein each of the first and the second polymeric compositions comprises about 100 parts by weight of an acrylic resin syrup, about 0.1 to about 10 parts by weight of an initiator, and about 20 to about 250 parts by weight of an inorganic filler.

13. The method of claim 12, wherein each of the first and the second polymeric compositions further comprises about 0 to about 100 parts by weight of marble chips.

14. The method of claim 1, wherein the second polymeric composition is provided over the first polymeric composition in a zigzag or a straight manner.

15. The method of claim 1, wherein curing the first and the second polymeric compositions comprises heating the compositions to a temperature between about 15° C. and about 80° C.

16. The method of claim 15, wherein curing the first and the second polymeric compositions comprises heating the compositions to a temperature between about 60° C. and about 80° C.

17. An artificial marble having a crack pattern made by the method of claim 1.

18. An article comprising the artificial marble of claim 17.
